(19) United States
(12) Patent Application Publication
(10) Pub. No.: US 2023/0012765 A1
(43) Pub. Date: Jan. 19, 2023

(54) METHOD FOR PRODUCING A MEASUREMENT TUBE ASSEMBLY FOR A CORIOLIS FLOW METER

(71) Applicant: Endress+Hauser Flowtec AG, Reinach (CH)

(72) Inventors: Frank Voigt, Weil am Rhein (DE); Ennio Bitto, Aesch (CH)

(21) Appl. No.: 17/757,297

(22) PCT Filed: Dec. 1, 2020
(86) PCT No.: PCT/EP2020/084130

§ 371 Date: Jun. 13, 2022

(30) Foreign Application Priority Data
Dec. 16, 2019 (DE) 102019134609.6

(51) Int. Cl. G01F 1/84

(52) U.S. Cl. CPC G01F 1/8404; G01F 1/8477

(57) ABSTRACT

A method for producing a measurement tube assembly for a Coriolis flow meter includes: providing a core assembly and a mold, which define a cavity therebetween, the core assembly a core that includes a core body of a first material; filling the cavity with a second material to form a measurement tube body of the measurement tube assembly, the second material having a higher melting temperature than the first material; separating the mold and the core assembly from the measurement tube assembly melting the at a melting temperature that is below the melting temperature of the second material and above the melting temperature of the first material. The present disclosure further includes a Coriolis flow meter and to a use of a lost-core method to produce a measurement tube assembly.

The invention relates to a method for producing a measurement tube assembly of a Coriolis flow meter, a Coriolis flow meter, and the use of a core melting method for producing a measurement tube assembly of a Coriolis flow meter.

Process measurement technology field devices with a sensor of the vibration type and especially Coriolis flow meters have been known for many years. The basic structure of such a meter is described, for example, in EP 1 807 681 A1, and reference is made in full to this publication with respect to the structure of a generic field device within the scope of the present invention.

Typically, Coriolis flow meters have at least one or more vibratable measuring tubes which can be set into vibration by means of a vibration exciter. These vibrations pass along the tube length and are varied by the type of flowable medium located in the measuring tube and its flow speed. At another point in the measuring tube, a vibration sensor or, in particular, two vibration sensors spaced apart from each other can record the varied vibrations in the form of a measurement signal or several measurement signals. An evaluation unit can then determine the mass flow, the viscosity, and/or the density of the medium from the measuring signal(s).

Coriolis flow meters usually have metallic measurement tubes. Only a few Coriolis flow meters with non-metallic measurement tubes have existed until now. WO 2011/099989 A1, for example, teaches a method for producing a monolithic measurement tube assembly of a Coriolis flow meter with curved measurement tubes, wherein the measurement tube body of the respective measurement tubes is first formed in solid form from a polymer, and the channel for guiding a flowable medium is then made by a chip formation process. However, such a production method is very complicated in terms of production and cost-intensive, which reduces its attractiveness for single-use applications.

The aim of the invention is to provide an alternative method for producing a measurement tube assembly of a Coriolis flow meter, with which measurement tubes can be produced which are suitable for flow measurements based upon the Coriolis principle.

The invention is also based upon the aim of providing a Coriolis flow meter with a measurement tube assembly manufactured from a plastic, in which the respective inner contour and outer contour of the measurement tubes have reproducible dimensions.

The aim is achieved by the method according to claim 1, the Coriolis flow meter according to claim 10, and the use according to claim 11.

The method according to the invention for producing a measurement tube assembly for a Coriolis flow meter comprises the method steps of:
providing a core assembly and a mold in order to form a cavity between the core assembly and the mold;
the core assembly comprising at least one core,
the core comprising a core body, which has a first material;
filling up the cavity with a second material in order to form a measurement tube body of a measurement tube of the measurement tube assembly,
the second material having a higher melting temperature than the first material;
separating the mold and the core assembly from the measurement tube assembly,
the core assembly being separated by means of the melting of the at least one core of the core assembly at a melting temperature which lies below the melting temperature of the second material and above the melting temperature of the first material.

The cavity is preferably filled up by means of a primary molding process, in particular by means of injection molding.

A low-melting metal alloy, in particular a bismuth, tin, zinc, and/or magnesium alloy, and preferably a tin-bismuth, tin-zinc, tin-lead, and/or tin-magnesium alloy, is preferably suitable as the first material. The first material can also have a filler, which has a higher melting temperature than the second material, for reducing the material requirement of the first material. The filler is removed from the measurement tube assembly when the liquefied first material is poured out. A filler comprises sand and/or glass.

A polyamide (PA), polyphthalamide (PPA), polyphenylene sulfide (PPS), polyether ether ketone (PEEK), polyaryletherketone (PAEK), polyphenylsulfone (PPSU), polyethersulfone (PESU), polysulfone (PSU), polyarylamide (PARA), is preferably suitable as the second material.

The melting can be performed, for example, in a melt bath and/or by means of inductive melting.

Such a method allows complex shapes to be realized for the measurement tube assembly, which have, for example, undercuts and thus cannot be implemented using conventional primary molding methods, in particular by means of injection molding. Such injection-molded parts cannot be demolded. The outer shape of the measurement tube assembly is defined by the design of the mold. The mold can have a multi-part design, as a result of which it permits the production of measurement tube assemblies having measurement tubes with a partially or completely circular, square, or oval cross-section.

Such a measurement tube assembly is particularly suitable as a single-use flow meter for applications in the medical field. In this case, the vibration exciter and the vibration sensors are arranged on a carrier body, in or on which the measurement tube assembly is arranged in a mechanically-separable manner.

Advantageous embodiment of the invention form the subject matter of the dependent claims.

One embodiment provides for the at least one core to have a bend.

Measurement tube assemblies for Coriolis flow meters are known which have curved measurement tubes. For this purpose, a usually straight, metallic starting tube is bent by introducing a bending force acting at least in some sections from the outside on the starting tube. Such a method is not suitable for measurement tubes which are made of plastic and would also be suitable for use in a Coriolis flow meter. Plastic measurement tubes which can be deformed well usually have a low quality factor and/or a low natural frequency. On the other hand, plastic measurement tubes which would be suitable for use in a Coriolis flow meter are very hard and cannot be bent. The method according to the invention makes it possible to produce curved measurement tubes which are formed from a plastic which has a high quality factor and reproducible acoustic properties. According to the invention, a core assembly with at least one core having a curve is used for the injection-molding process. The measurement tube thus obtained, or the measurement tube assembly thus obtained, cannot be demolded. The demolding takes place by melting the core assembly.

One embodiment provides for the core to have at least two sections which run parallel to one another, wherein the bend is between two of the at least two sections.

As a result, a cost-effective and compact, U-shaped measurement tube assembly can be realized which can be attached to the carrier body in an easy-to-mount manner, even when protective suits are worn, such as is usual in clean rooms or in the laboratory, for example.

One embodiment provides for the mold to have at least one receptacle in which a magnetic device is inserted, wherein the magnetic device is overmolded with the second material when the cavity is filled up, so that the magnetic device is fastened in a form-fitting manner in the formed measurement tube body.

Vibration exciters and vibration sensors each comprise at least one magnetic device which has magnets, which can also often be formed as magnetic cups, and at least one coil. According to the invention, the magnetic device is at least partially encapsulated by the second material and thus fixed to the measurement tube assembly in a form-fitting manner. Subsequent attachment and fixing of the magnets is therefore no longer necessary. This results not only in reproducible measurement tube assemblies, but also in leaner production processes.

One embodiment provides for the mold to have at least one bulge for forming a recess in the formed measurement tube body, wherein the recess is designed to receive at least one magnetic device.

As an alternative to the above embodiment, bulges can also be provided in the mold, which leave recesses in the measurement tube which are designed to receive magnets. The magnets are glued into the receptacles. A simple positioning and reproducible attachment of the magnets to the measurement tube device can thus be achieved. This is particularly important because, in single-use measurement tube assemblies, it is desirable to avoid inconvenient adjustment, and this can only be avoided if the measurement tube assembly can be produced as reproducibly as possible.

One embodiment provides for the core assembly to comprise exactly two cores, wherein the two cores and the mold form a first cavity and a second cavity for forming two measurement tubes, wherein the mold forms at least one third cavity which connects the first cavity and the second cavity, wherein a coupler element body, which connects the two measurement tubes to one another, is formed when the third cavity is filled up.

Measurement tube assemblies of Coriolis flow meters with at least two measurement tubes generally have coupling elements which connect the individual measurement tubes to one another and thus form a single vibrator from the measurement tube assembly. In conventional Coriolis flow meters, these coupling elements are pushed onto the measurement tube assembly and soldered thereto. Such a fixing would not be feasible, or could only be realized very laboriously, for the present measurement tube assembly made of plastic.

It is advantageous if, when the mold is brought together with the core assembly, a second cavity is formed which acts as a casting mold for the coupler element body. This obviates the subsequent attachment and fixing of the coupler elements to the measurement tube assembly. Specifically, a coupler element body is formed during injection molding and connects the measurement tubes to one another. In this case, the coupler element body is connected monolithically to the measurement tube assembly. Furthermore, it is thus ensured that the coupling quality of the coupler elements and thus also the vibration behavior of the individual measurement tube assemblies can be produced so as to be reproducible.

One embodiment provides for at least one first support body to be arranged in the third cavity, said first support body being designed to increase the mechanical strength of the coupler element body, wherein the first support body has a third material having a third melting temperature which is higher than the first melting temperature.

In order to increase the strength of the coupler element body or to improve the coupling effect, it is advantageous to integrate a first support body into the coupler element body, in particular to cast it together with the same.

However, the first support body can also assume the function of the coupler element. In this case, the casting compound extending into the third cavity is used to connect the support body to the measurement tube assembly in a form-fitting manner.

One embodiment provides for the core assembly to comprise exactly two cores,
wherein the two cores and the mold form a first cavity and a second cavity for forming two measurement tubes,
wherein the mold and the cores form a further, fourth cavity,
wherein the fourth cavity is intersected in each case twice by the two cores,
wherein a decoupling body, which connects the two measurement tubes to one another, is formed when the fourth cavity is filled up.

Precisely in the case of single-use applications, it is essential to implement the exchangeable part of the Coriolis flow meter such that it can be attached reproducibly. This means that the vibration behavior of the measurement tubes during adjustment of the measurement tube assembly must correspond to the vibration behavior of the measurement tubes after installation in the system at the customer. Furthermore, it is advantageous if the exchangeable part is not only mechanically fixedly arranged on the carrier body, but can also be mechanically decoupled as far as possible from the line system for guiding the flowable medium.

It has been found to be advantageous to provide the measurement tube assembly with a decoupling body which has mounting surfaces for reproducible attachment and fixing of the measurement tube assembly in a carrier assembly, and which is designed to reduce external influences on the flow measurement. Furthermore, the decoupling body is used to reduce micro-friction at the boundary surfaces to the carrier body.

One embodiment provides for a second support body to be arranged in the fourth cavity, said second support body being designed to increase the mechanical strength of the decoupling body, wherein the second support body has a fourth material having a fourth melting temperature which is higher than the melting temperature of the first material.

A refinement of the above embodiment provides for a second support body in the decoupling body to increase the mechanical strength.

Alternatively, the second support body replaces the decoupling body, or the decoupling body corresponds to the second support body. In this case, a form-fitting connection between the second support body and the measurement tube assembly is realized by the introduction and solidification of the casting compound in the fourth cavity.

The Coriolis flow meter according to the invention comprises:
a measurement tube assembly;
at least one vibration exciter which is designed to excite the measurement tube assembly to vibrate;
at least one vibration sensor which is designed to detect the deflection of the vibrations of the measurement tube assembly,
   and is characterized in that the measurement tube assembly is produced by means of the method according to the invention.

According to the invention, a lost-core method is used in a primary molding method, in particular during injection molding for producing a measurement tube assembly for a Coriolis flow meter.

The lost-core method is used primarily in the automotive industry. It permits any conceivable part contour, such as pipes with multiple bends. Thus, non-demoldable plastic parts can also be realized by injection molding. The inner surfaces of the manufactured parts can be structured in a targeted manner.

The invention is explained in greater detail with reference to the following figures. The following are shown:

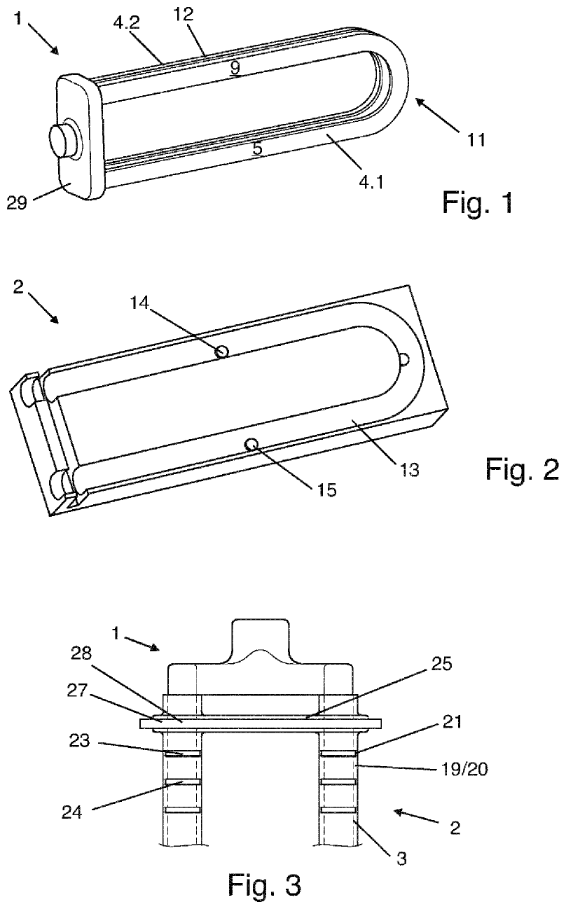

FIG. 1: an embodiment of the core assembly according to the invention;

FIG. 2: a longitudinal section through an embodiment of the mold according to the invention;

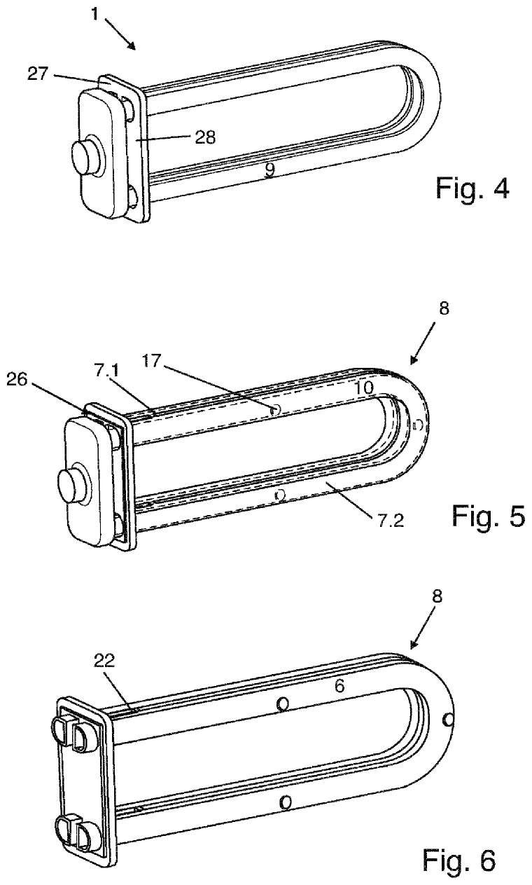

FIG. 3: a cutout of a core assembly inserted into the mold;

FIG. 4: a further embodiment of the core assembly according to the invention, with a support body;

FIG. 5: an encapsulated core assembly;

FIG. 6: a measurement tube assembly with the core assembly melted out;

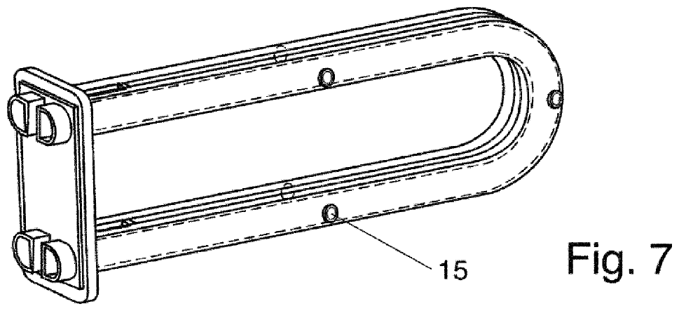

FIG. 7: a measurement tube assembly with attached magnets;

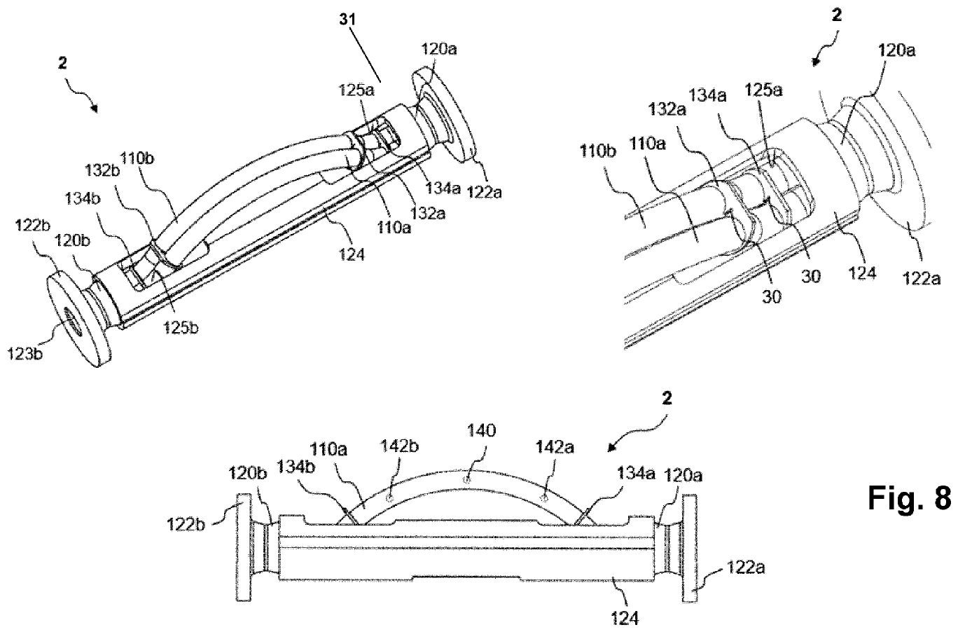

FIG. 8: three views of a Coriolis flow meter according to the invention.

FIG. 1 shows an embodiment of a core assembly 1 which, together with the mold, is used to form a cavity or a hollow space which defines the shape and surface structure of the manufactured measurement tube assembly. According to the illustrated embodiment, the core assembly 1 has two cores 4.1, 4.2, which are connected to one another via a connecting body 29. The connecting body is used to arrange and fix the core assembly 1 as easily as possible in the mold in a position predetermined for this purpose. The connecting body 19 can be connected monolithically to the core assembly 1, or can be attached in a form-fitting and/or force-fitting manner. Both cores 4.1, 4.2 each have two sections 12.1, 12.2, in which the respective longitudinal axes of the core run parallel to one another, and a bend 11, which is arranged between the two sections 12.1, 12.2. Thus, the component produced by injection molding also has a curve. The channel for guiding the flowable medium in the measurement tube is essentially U-shaped. The core body 5 has a first material 9 which has a lower melting temperature than the melting temperature of the second material from which the measurement tube body is formed. The core assembly 1 has two mirror planes, which are perpendicular to one another and divide the core assembly 1 into two parts. A first mirror plane runs between the two cores. The second mirror plane intersects the two cores 4.1, 4.2 in the curved region, wherein the longitudinal axes of the two sections 12.1, 12.2 are spaced equally far from the second mirror plane. The cores 4.1, 4.2 are partially cylindrical, or have a circular cross-sectional area. The cores 4.1, 4.2 can also each have a multi-part design, i.e., consist of multiple individual parts which form the respective core 4.1, 4.2 when put together.

FIG. 2 shows a longitudinal section through an embodiment of the mold 2 into which the core assembly is inserted and which, together with the core assembly, forms a cavity for casting with flowable plastic and forming a measurement tube assembly. The mold can have a multi-part design. The mold 2 comprises a channel which has two regions 13.1, 13.2 which are each formed parallel to one another and are connected to one another by means of a curve. According to the depicted embodiment, in the two regions 13.1, 13.2, receptacles 14 for magnets of the magnetic device 15 are arranged in the mold 2. The magnets are attached in the receptacle in such a way that they are connected to the respective measurement tube bodies in a form-fitting manner when the measurement tube assembly is formed. The magnets of the magnetic device 15 are components of the vibration sensors and of the vibration exciter.

The mold can have a receptacle for the connecting body of the core assembly, which receptacle is used to fix the core assembly in a predetermined position.

FIG. 3 shows a detail of the core assembly 1 from FIG. 1, arranged in the mold 2 of FIG. 2. A cavity 3 is formed in the process which, later in the course of the method, is filled with the casting compound, in particular the liquid plastic, and defines the shape of the measurement tube assembly. The core assembly 1 and the mold 2 form a first cavity 19 and a second cavity 20. After the third cavity 21 has been filled with a casting compound, and the casting compound has cured, the measurement tube body is formed in the first cavity 19 and in the second cavity 20. Six first support bodies 23 are attached to the core assembly 1 and, with the mold 2, each form a third cavity 21. Three of the first support bodies 23 are attached in the inlet section, and three of the first support bodies 23 are attached in the outlet section, of the core assembly 1. The first support bodies 23 connect the cores to one another in the respective sections. The first support body 23 has a fourth material 28 which has a melting temperature which is higher than the melting temperature of the first material 9 of the core body 5 of the core assembly 1. After the third cavity 21 has been filled with a casting compound, and the casting compound has cured, a coupler element with a coupler element body is formed in the third cavity 21.

A second support body 27, which has a fourth material 28 having a melting temperature which is higher than the melting temperature of the first material 9, is also attached to the core assembly 1. A fourth cavity 25 is formed between the second support body 27 and the mold 2, and forms a decoupling body when filled.

FIG. 4 shows a further embodiment of the core assembly 1, which has at least all the essential features of the embodiment shown in FIG. 1. In addition, a second support body 27 is attached to the core assembly 1. The second support body 27 comprises a fourth material 28 which has a higher melting temperature than the melting temperature of the first material 9. The second support body 27 is used to connect the two measurement tubes of the measurement tube assembly to one another, and thus mechanically couple them from the surroundings. The second support body 27 connects the respective inlet sections of the cores to one another and to the outlet sections of the cores.

FIG. 5 shows an overmolded and demolded core assembly 1 of FIG. 4. The plastic injected in liquid form forms the measurement tube assembly 8 with the coupler element body 22. The mold has been removed. The measurement tube assembly 8 has two measurement tubes 7.1, 7.2, each of which is formed from a second material 10. The melting temperature of the second material 10 is higher than the melting temperature of the first material. The first support body 23 is integrated into the coupler element body 22 and is at least partially enclosed by the cured casting compound. Furthermore, the measurement tube assembly 8 has a decoupling body 26, which comprises the second support body.

FIG. 6 shows the measurement tube assembly 8 with the core assembly melted out. The measurement tube assembly 8 comprises a measurement tube body 6. The measurement tube body 6 has receptacles for the magnetic device. The two measurement tubes are connected to one another via two coupler elements 22, which are arranged in the inlet and outlet regions. The coupler elements 22 assume the shape of the third cavity. s

FIG. 7 shows the measurement tube assembly 8 of FIG. 6 with an attached magnetic device 15. The magnets of the magnetic device are arranged in the receptacles and are connected to the measurement tube body in an integrally-bonded and/or form-fitting manner.

The embodiment of a Coriolis flow meter according to the invention shown in FIG. 8 comprises a measurement tube assembly which is produced by means of the method according to the invention and comprises two, parallel, curved measurement tubes 110a, 110b, which extend between an inlet-side collector 120a and an outlet-side collector 120b, and are fixedly connected thereto. Extending between the collectors 120a, 120b is a solid carrier tube or carrier body 124 fixedly connected to the two collectors, thereby rigidly coupling the collectors 120a, 120b to each other. The carrier tube 124 has, on its upper side, openings 125a, 125b, through which the measurement tubes 110a, 110b run from the collectors out of the carrier tube 124 and back again. The measurement tubes 110a, 110b are connected on the inlet side and outlet side to two coupler elements 132a, 134a, 132b, 134b in each case, said coupler elements being produced by the method according to the invention, wherein the coupler elements each have a continuous hole 30 between the measurement tubes, said hole being used to reduce the stiffness in the Y-direction of the geometric center in the second region between the two measurement tubes. The coupler elements 132a, 132b, 134a, 134b define vibration nodes for the measurement tubes. Between the inner coupler elements 132a, 132b, the measurement tubes 110a, 110b can vibrate freely, so that the vibration properties of the vibrator formed by the measurement tubes 110a, 110b, in particular natural frequencies of vibration modes of the vibrator, are substantially also determined by the position of the inner coupler elements. The measurement tubes are formed from glass or plastic.

For exciting vibrations relative to the longitudinal direction or the Z-axis in the center of the flow meter 100, an exciter assembly 140, e.g., an inductive exciter assembly, is provided between the measurement tubes, said exciter assembly comprising, for example, a plunger coil on one measurement tube and, opposite the plunger body, a measurement tube or a magnet on the measurement tube, and a semiconductor coil on the carrier tube. For detecting the vibrations of the measurement tubes, a first sensor assembly 142a and a second sensor assembly 142b are provided in the longitudinal direction, symmetrically with respect to the exciter assembly 140, and are each designed as an inductive assembly with a plunger coil on one tube and a plunger body on the other tube. Details are known to the person skilled in the art and need not be explained here.

The collectors 120a, 120b have end flanges 122a, 122b, by means of which the meter can be installed in a pipeline. Through central openings 123b in the flanges, a mass flow can be conducted through the meter 100, in particular its pipelines 110a, 110b, in order to measure the mass flow.

The measurement tubes 110a, 110b are connected on the inlet side and outlet side to two coupler elements 132a, 134a, 132b, 134b in each case, wherein the coupler elements each have a hole 30 between the measurement tubes.

### LIST OF REFERENCE SIGNS

1 Core assembly 1
2 Mold 2
3 Cavity 3
4 Core 4
5 Core body 5
6 Measurement tube body 6
7 Measurement tube 7
8 Measurement tube assembly 8
9 First material 9
10 Second material 10
11 Bend 11
12 Region 12
13 Region 13
14 Receptacle 14
15 Magnetic device 15
17 Recess
19 First cavity 19
20 Second cavity 20
21 Third cavity 21
22 Coupler element 22
23 First support body 23
24 Third material 24
25 Fourth cavity 25
26 Decoupling body 26
27 Second support body 27
28 Fourth material 28
29 Connecting body 29
110a Curved measurement tube
110b Curved measurement tube
120a Inlet-side collector
120b Outlet-side collector
122a End flange
122b End flange
123a Inlet
123b Outlet
124 Carrier tube
125a Opening in upper side
125b Opening in upper side
132a Coupler element
132b Coupler element
134a Coupler element
134b Coupler element
140 Vibration exciter
142a Vibration sensor
142b Vibration sensor
146 Tuning opening

1-11. (canceled)

12. A method for producing a measurement tube assembly for a Coriolis flow meter, the method comprising:
providing a core assembly and a mold configured to define a cavity between the core assembly and the mold, wherein the core assembly comprising at least one core, the at least one core comprising a core body, comprising a first material having a first melting temperature;
filling the cavity with a second material as to form a measurement tube body of a measurement tube of the measurement tube assembly, the second material having a second melting temperature that is higher than the first melting temperature;
separating the mold and the core assembly from the measurement tube assembly, wherein the core assembly is separated by melting of the at least one core of the core assembly at a process melting temperature that is below the melting temperature of the second material and above the melting temperature of the first material.

13. The method of claim 12, wherein the at least one core includes a bend.

14. The method of claim 13, wherein the at least core includes at least two regions that run parallel to one another, and wherein the bend is between two of the at least two regions.

15. The method of claim 12, wherein the mold has at least one receptacle in which a magnetic device is inserted,
wherein the magnetic device is overmolded with the second material when the cavity is filled such that the magnetic device is secured in a form-fitting manner in the formed measurement tube body.

16. The method of claim 12, wherein the mold includes at least one bulge configured to form a recess in the formed measurement tube body, and wherein the recess is configured to receive at least one magnetic device.

17. The method of claim 12, wherein:
the at least one core of the core assembly comprises exactly two cores;
the two cores and the mold define a first cavity and a second cavity configured to form two measurement tubes;
the mold defines at least a third cavity that connects the first cavity and the second cavity; and
a coupler element body, which connects the two measurement tubes to each other, is formed when the at least third cavity is filled.

18. The method of claim 17, wherein a first support body is arranged in the third cavity, the first support body configured to increase the mechanical strength of the coupler element body, and wherein the first support body comprises a third material having a third melting temperature that is higher than the first melting temperature.

19. The method of claim 12, wherein:
the at least one core of the core assembly comprises exactly two cores;
the two cores and the mold define a first cavity and a second cavity configured to form two measurement tubes;
the mold and the cores define a fourth cavity;
the fourth cavity is intersected in each case twice by the two cores; and
a decoupling body, which connects the two measurement tubes to each other, is formed when the fourth cavity is filled.

20. The method of claim 19, wherein a second support body is arranged in the fourth cavity, the second support body configured to increase the mechanical strength of the decoupling body, and wherein the second support body comprises a fourth material having a fourth melting temperature that is higher than the first melting temperature.

21. A Coriolis flow meter, comprising:
a measurement tube assembly;
at least one vibration exciter which is designed to excite the measurement tube assembly to vibrate; and
at least one vibration sensor which is designed to detect the deflection of the vibrations of the measurement tube assembly,
wherein the measurement tube assembly is produced by the method according to claim 12.

22. A method for producing a measurement tube assembly for a Coriolis flow meter, the method comprising:
using a lost-core method in an injection molding process to produce the measurement tube assembly.
